(19) United States
(12) Patent Application Publication
(10) Pub. No.: US 2025/0304175 A1
(43) Pub. Date: Oct. 2, 2025

(54) VEHICLE LOWER PART STRUCTURE

(71) Applicant: TOYOTA JIDOSHA KABUSHIKI KAISHA, Toyota-shi (JP)

(72) Inventors: Takeshi SASE, Nagakute-shi (JP); Takayoshi Shigihara, Toyota-shi (JP)

(73) Assignee: TOYOTA JIDOSHA KABUSHIKI KAISHA, Toyota-shi (JP)

(21) Appl. No.: 18/987,450

(22) Filed: Dec. 19, 2024

(30) Foreign Application Priority Data
Apr. 1, 2024 (JP) 2024-059037

(51) Int. Cl. B62D 21/15; B60R 16/04; B62D 21/11

(52) U.S. Cl. CPC B62D 21/155; B60R 16/04; B62D 21/11

(57) ABSTRACT

A pair of right and left side rails connected to the cross member and the cross member and extending in the vehicle front-rear direction and having a rear end connected to the battery, and an arm support portion provided at an intermediate portion in the front-rear direction of the side rail and supporting a lower arm for supporting the front wheel, and a suspension member provided in the vehicle, and a shear panel positioned between the rear portions of the pair of side rails as viewed in plan, and having a front closed-section structure portion extending along a straight line connecting the right and left arm support portions and connected to the pair of side rails as viewed in plan.

### CROSS-REFERENCE TO RELATED APPLICATION

This application claims priority to Japanese Patent Application No. 2024-059037 filed on Apr. 1, 2024, incorporated herein by reference in its entirety.

### BACKGROUND

### 1. Technical Field

The present disclosure relates to vehicle lower part structures.

### 2. Description of Related Art

Japanese Unexamined Patent Application Publication No. 2020-29245 (JP 2020-29245 A) discloses a protector connecting a suspension member and a battery of a vehicle.

### SUMMARY

It is sometimes desired to increase the amount of deformation of a front portion of a suspension member while reducing the amount of deformation of a rear portion of the suspension member in the event of a frontal collision of a vehicle. It is also sometimes desired to improve the rigidity of lower arm force receiving portions of the suspension member. The lower arm force receiving portions are portions that receive a force transmitted from lower arms to the suspension member when a steering wheel is steered. The disclosure of JP 2020-29245 A has room for improvement in these points.

In view of the above, it is an object of the present disclosure to allow a suspension member to absorb a collision load while reducing the amount of deformation of a rear portion of the suspension member in the event of a frontal collision of a vehicle. It is another object of the present disclosure to provide a vehicle lower part structure that allows to improve the rigidity of lower arm force receiving portions of the suspension member, namely portions that receive a force transmitted from lower arms to the suspension member when a steering wheel is steered.

A vehicle lower part structure of claim 1 includes a suspension member and a shear panel.
The suspension member is installed in a vehicle and includes a cross member, a pair of right and left side rails, and arm support portions. The side rails are connected to the cross member and extend in a vehicle front-rear direction. Rear ends of the side rails are connected to a battery. Each of the arm support portions is provided on an intermediate portion in a front-rear direction of a corresponding one of the side rails, and supports a corresponding one of lower arms that support front wheels whose steering angle changes when a steering wheel is steered.
The shear panel is located between rear portions of the side rails as viewed in plan and includes a front closed-section structure portion. The front closed-section structure portion extend along a straight line connecting the right and left arm support portions as viewed in plan, and is connected to the side rails.

According to the vehicle lower part structure of claim 1, when a frontal collision of the vehicle occurs, the battery receives rearward movement of the suspension member, so that the side rails receive a reaction force from the battery. Since the front closed-section structure portion extending along the straight line connecting the right and left arm support portions is connected to the intermediate portions in the front-rear direction of the right and left side rails, mechanical strength of the intermediate portions of the side rails is higher than that of portions forward of the intermediate portions of the side rails. This configuration therefore allows the portions forward of the intermediate portions of the right and left side rails to be intentionally deformed when the side rails receive a reaction force from the battery. That is, this configuration allows the suspension member to absorb a collision load while reducing the amount of deformation of a rear portion of the suspension member in the event of a frontal collision of the vehicle.

Moreover, in the vehicle lower part structure of claim 1, a force transmitted from the lower arms to lower arm force receiving portions of the suspension member when the steering wheel is steered is received by the front closed-section structure portion extending along the straight line connecting the right and left arm support portions as viewed in plan. This configuration allows to improve the rigidity of the lower arm force receiving portions of the suspension member, namely the portions that receive the force transmitted from the lower arms to the suspension member when the steering wheel is steered.

According to a vehicle lower part structure of claim 2, in claim 1, each of the side rails may include a connected portion connected to a corresponding one of front side members and located rearward of a corresponding one of the arm support portions, and
the shear panel may include
a first intermediate closed-section structure portion connecting a right end of the front closed-section structure portion and the connected portion of the left side rail as viewed in plan and connected to the connected portion of the left side rail, and
a second intermediate closed-section structure portion connecting a left end of the front closed-section structure portion and the connected portion of the right side rail as viewed in plan and connected to the connected portion of the right side rail.

In the vehicle lower part structure of claim 2, a rear end of the first intermediate closed-section structure portion of the shear panel is connected to the connected portion of the left side rail, and a rear end of the second intermediate closed-section structure portion of the shear panel is connected to the connected portion of the right side rail. Mechanical strength of portions rearward of the intermediate portions of the side rails is therefore higher than that of the portions forward of the intermediate portions of the side rails. Accordingly, the suspension member is more likely to absorb a collision load while reducing the amount of deformation of the rear portion of the suspension member in the event of a frontal collision of the vehicle. Moreover, part of the force transmitted from the lower arms to the lower arm force receiving portions of the suspension member when the steering wheel is steered is received by the first intermediate closed-section structure portion and the second intermediate closed-section structure portion. This configuration allows to improve the rigidity of the lower arm force receiving portions of the suspension member, namely the portions that receive the force transmitted from the lower arms to the suspension member when the steering wheel is steered.

According to a vehicle lower part structure of claim 3, in claim 2, the vehicle lower part structure may further include:
a first rear closed-section structure portion extending from a right end of the second intermediate closed-section structure portion obliquely rearward to left as viewed in plan; and
a second rear closed-section structure portion extending from a left end of the first intermediate closed-section structure portion obliquely rearward to right as viewed in plan, a rear end of the second rear closed-section structure portion being connected to a rear end of the first rear closed-section structure portion and the battery.

In the vehicle lower part structure of claim 3, the first intermediate closed-section structure portion, the second intermediate closed-section structure portion, the first rear closed-section structure portion, and the second rear closed-section structure portion form an annular structure. This improves mechanical strength of the shear panel. This makes it easier to make the mechanical strength of the portions rearward of the intermediate portions of the side rails higher than that of the portions forward of the intermediate portions of the side rails. Accordingly, the suspension member is more likely to absorb a collision load while reducing the amount of deformation of the rear portion of the suspension member in the event of a frontal collision of the vehicle. This configuration also allows to improve the rigidity of the lower arm force receiving portions of the suspension member, namely the portions that receive the force transmitted from the lower arms to the suspension member when the steering wheel is steered.

According to a vehicle lower part structure of claim 4, in claim 1 or 2, each of the side rails may include a bent portion located forward of the front closed-section structure portion.

In the vehicle lower part structure of claim 4, the bent portions of the right and left side rails tend to be deformed when the side rails receive a reaction force from the battery.

The vehicle lower part structure according to the present disclosure is highly advantageous in that it allows the suspension member to absorb a collision load while reducing the amount of deformation of the rear portion of the suspension member in the event of a frontal collision of the vehicle. The vehicle lower part structure according to the present disclosure is also highly advantageous in that it allows to improve the rigidity of the lower arm force receiving portions of the suspension member, namely the portions that receive the force transmitted from the lower arms to the suspension member when the steering wheel is steered.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view illustrating components of a front portion of a vehicle to which a vehicle lower part structure according to an embodiment is applied;

FIG. 2 is a side view of a suspension member;

FIG. 3 is a sectional view taken along line 3-3 of FIG. 1;

FIG. 4 is a sectional view taken along line 4-4 of FIG. 1;

FIG. 5 is a sectional view taken along line 5-5 of FIG. 1; and

FIG. 6 is a sectional view taken along line 6-6 of FIG. 1.

### DETAILED DESCRIPTION OF EMBODIMENTS

Hereinafter, an embodiment of a vehicle lower part structure according to the present disclosure will be described with reference to the accompanying drawings. Note that an arrow FR appropriately shown in the drawings indicates the front side of the vehicle which is the front side in the vehicle front-rear direction, an arrow LH indicates the left side of the vehicle which is the left side in the vehicle left-right direction, and an arrow UP indicates the upper side of the vehicle which is the upper side in the vehicle vertical direction. In the following description, the front-rear direction, the left-right direction, and the up-down direction represent the vehicle front-rear direction, the vehicle left-right direction, and the vehicle up-down direction, respectively.

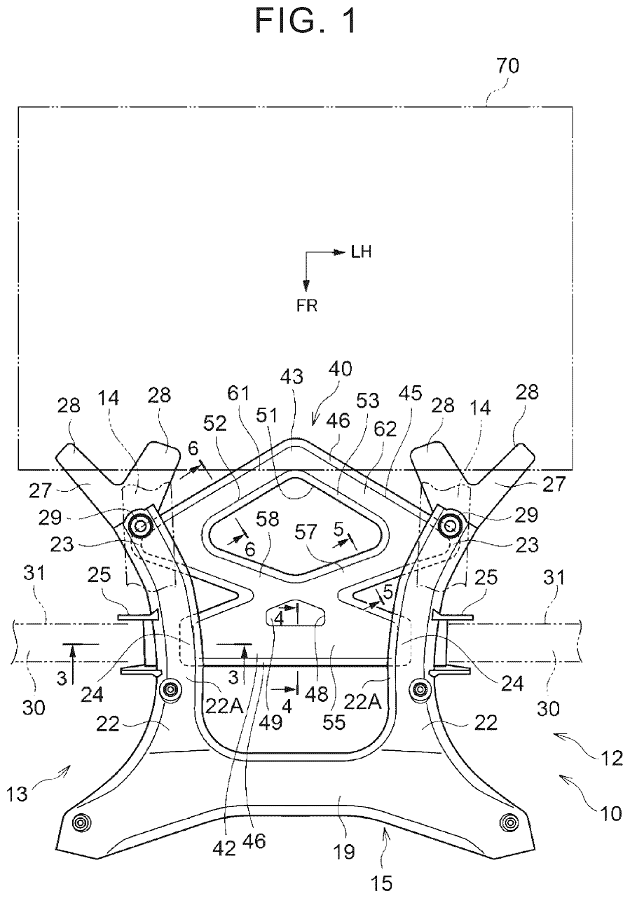

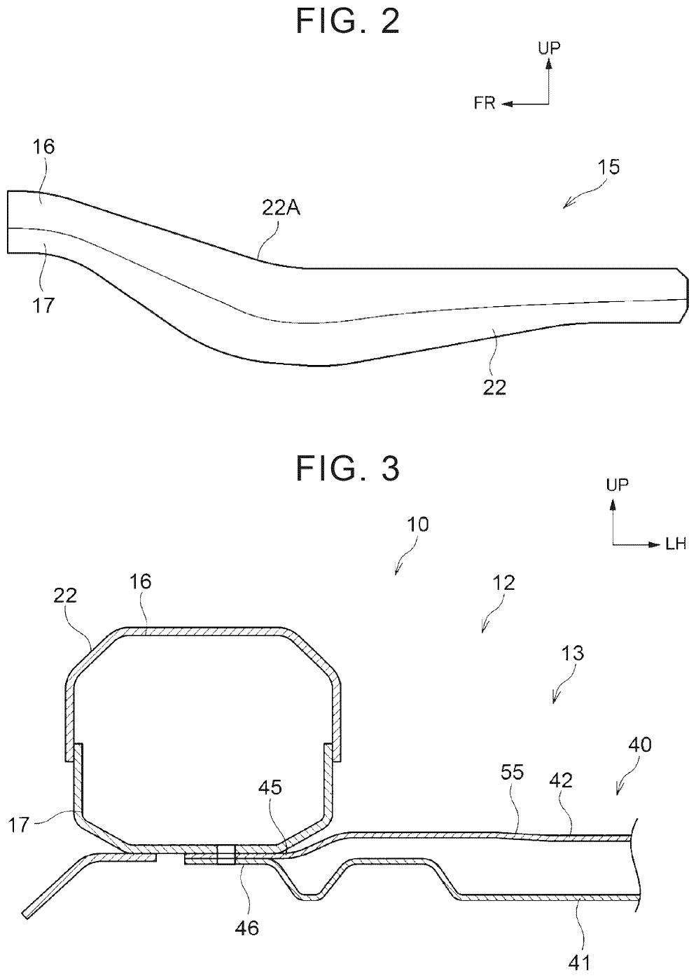

As illustrated in FIGS. 1 and 2, the vehicle lower part structure 13 applied to the front portion of the vehicle body 12 of the vehicle 10 includes a pair of right and left front side members 14 extending in the front-rear direction. Further, the vehicle lower part structure 13 includes a suspension member 15, a connection bracket 27, a lower arm 30, and a shear panel 40.

The metal suspension member 15 includes a cross member 19 extending in the left-right direction, a pair of right and left side rails 22 extending rearward from both right and left ends of the cross member 19, and a pair of right and left brackets (arm support portions) 25. As shown in FIG. 3, the cross member 19 and the side rail 22 are hollow bodies formed by joining the upper panel 16 constituting the upper portion of the suspension member 15 and the lower panel 17 constituting the lower portion of the suspension member 15. As shown in FIG. 1, the right and left side rails 22 are symmetrical as viewed in plan and have a substantially arc shape. Further, as shown in FIG. 2, intermediate portions in the longitudinal direction of the right and left side rails 22 are gently curved as viewed from the side. Further, a bent portion 22A is provided at a portion of the right and left side rails 22 which is spaced forward from the longitudinal center. The upper surface of the side rail 22 is recessed downward at the bent portion 22A. The suspension member 15 is located below the right and left front side members 14. The upper surface of the connected portion 23, which is a portion near the rear end of the right and left side rails 22, and a predetermined portion in front of the connected portion 23 of the right and left side rails 22 are fixed to the lower surfaces of the right and left front side members 14, respectively.

A metal bracket 25 having a substantially U-shaped planar shape is fixed to a central portion in the longitudinal direction of the outer side surfaces of the right and left side rails 22. That is, the bracket 25 is fixed to a support portion (lower arm attachment portion) 24 which is a predetermined portion of the side rail 22. Further, the rear ends of the right and left side rails 22 are connected to the front ends of the metal connection brackets 27 each having a substantially V-shaped planar shape via a connection pin 29 that penetrates the rear ends of the side rails 22 in the up-down direction.

The right and left brackets 25 are connected to the vehicle inner ends of the lower arms 30, respectively. The lower arm 30 includes a first arm (not shown) positioned on the front side and a second arm 31 located rearward of the first arm. The inner ends of the right and left second arms 31 are supported by the right and left brackets 25, respectively, and the inner ends of the right and left first arms are connected to a portion of the right and left side rails 22 that is forward of the brackets 25 (not shown). As shown in FIG. 1, the right and left second arms 31 are parallel to the left-right direction as viewed in plan. The right and left first arms are tilted with respect to the left-right direction as viewed in plan. The front wheels are respectively supported on the outer ends of the right and left lower arms 30 via knuckles and the like. The lower arm 30 may be, for example, a double wishbone type. When a steering wheel (not shown) provided in the vehicle 10 is rotated by an occupant, the steering angles of the right and left front wheels change.

The rear ends 28 of the two bifurcated portions of the right and left connection brackets 27 are fixed to the front portion of the battery 70 fixed to the vehicle body 12. That is, the right and left side rails 22 are connected to the battery 70 via the connection bracket 27. The battery 70 supplies electricity to, for example, an electric motor (not shown) that is a driving source of the vehicle 10. That is, the battery 70 is large and heavy.

The shear panel 40 is a metal member located below the rear portions of the right and left side rails 22. As shown in FIG. 3, the shear panel 40 includes a lower panel 41 and an upper panel 42 which are both made of metal and joined to each other. The first boundary line 45 shown in FIG. 1 has an annular shape having a substantially nine-angled planar shape. The portion of the shear panel 40 located on the outer peripheral side of the first boundary line 45 is constituted by an outer peripheral side flat plate portion 46 formed by joining the flat outer peripheral portion of the lower panel 41 and the flat outer peripheral portion of the upper panel 42. The second boundary line 48 shown in FIG. 1 has an annular shape having a substantially pentagonal planar shape. A portion of the shear panel 40 located on the inner peripheral side of the second boundary line 48 is a first inner peripheral side flat plate portion 49 formed by joining the flat plate-like portion of the lower panel 41 and the flat plate-like portion of the upper panel 42. As shown in FIG. 1, a through hole 51 having a substantially rhombic planar shape is formed in the rear portion of the shear panel 40. The third boundary line 52 shown in FIG. 1 has an annular shape in which the planar shape is substantially diamond-shaped and is located on the outer peripheral side of the through-hole 51. A portion between the through hole 51 and the third boundary line 52 in the shear panel 40 is a second inner peripheral side flat plate portion 53 formed by joining the flat plate-like portion of the lower panel 41 and the flat plate-like portion of the upper panel 42.

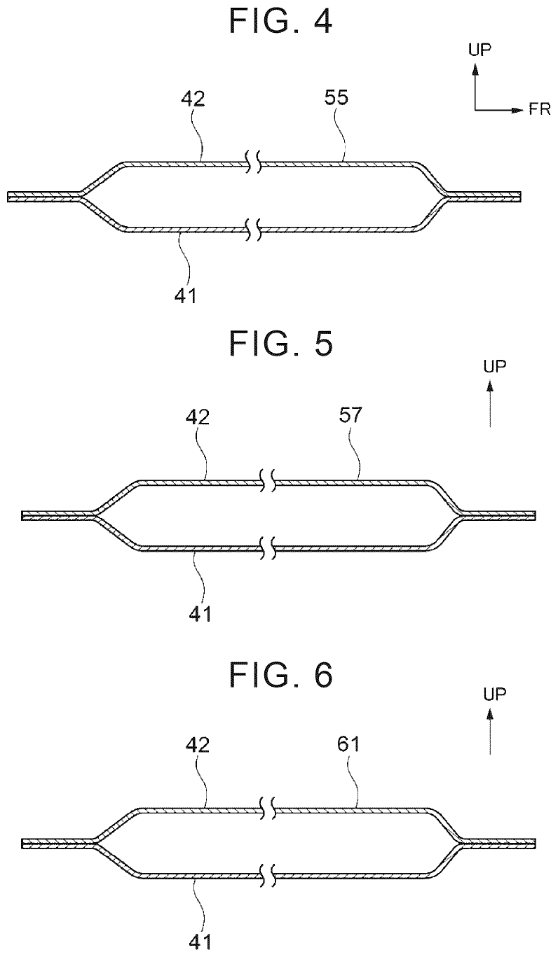

In the vicinity of the front end of the shear panel 40, a front closed-section structure portion 55 extending linearly along the left-right direction as viewed in plan is formed. As shown in FIGS. 3 and 4, the lower panel 41 and the upper panel 42 constituting the front closed-section structure portion 55 are vertically separated from each other. That is, the front closed-section structure portion 55 is a hollow portion extending linearly along the left-right direction. Further, as shown in FIG. 4, the cross-sectional shape of the front closed-section structure portion 55 when cut in a plane orthogonal to the left-right direction is annular. That is, the cross-sectional shape of the front closed-section structure portion 55 is a closed-section shape.

In a region between the front edge portion and the through-hole 51 of the shear panel 40, a first intermediate closed-section structure portion 57 and a second intermediate closed-section structure portion 58 that extend linearly along a direction inclined with respect to the left-right direction as viewed in plan are formed. The right end (front end) of the first intermediate closed-section structure portion 57 is connected to the right end of the front closed-section structure portion 55, and the left end (front end) of the second intermediate closed-section structure portion 58 is connected to the left end of the front closed-section structure portion 55. The central portions of the first intermediate closed-section structure portion 57 and the second intermediate closed-section structure portion 58 intersect each other. As shown in FIG. 5, the lower panel 41 and the upper panel 42 constituting the first intermediate closed-section structure portion 57 are vertically separated from each other. That is, the first intermediate closed-section structure portion 57 is a hollow portion extending linearly along a direction inclined with respect to the left-right direction. Further, when the first intermediate closed-section structure portion 57 is cut in a plane orthogonal to the extension direction of the first intermediate closed-section structure portion 57, the sectional shape is annular. That is, the sectional shape of the first intermediate closed-section structure portion 57 is a closed-section shape. Although not shown in the drawings, the second intermediate closed-section structure portion 58 is a hollow portion extending linearly along a direction inclined with respect to the left-right direction. That is, when the second intermediate closed-section structure portion 58 is cut in a plane orthogonal to the extension direction of the second intermediate closed-section structure portion 58, the sectional shape is annular.

In a region between the rear edge portion and the through hole 51 of the shear panel 40, a first rear closed-section structure portion 61 and a second rear closed-section structure portion 62 extending linearly along a direction inclined with respect to the left-right direction as viewed in plan are formed. The right end (front end) of the first rear closed-section structure portion 61 is connected to the right end (rear end) of the second intermediate closed-section structure portion 58, and the left end (front end) of the second rear closed-section structure portion 62 is connected to the left end (rear end) of the first intermediate closed-section structure portion 57. Further, the rear ends of the first rear closed-section structure portion 61 and the second rear closed-section structure portion 62 are connected to each other. The rear ends of the first rear closed-section structure portion 61 and the second rear closed-section structure portion 62 and the peripheral portions thereof constitute the rear end 43 of the shear panel 40. As shown in FIG. 1, the rear end 43 is fixed to the front portion of the battery 70.

As shown in FIG. 6, the lower panel 41 and the upper panel 42 constituting the first rear closed-section structure portion 61 are vertically separated from each other. That is, the first rear closed-section structure portion 61 is a hollow portion extending linearly along a direction inclined with respect to the left-right direction. Further, the sectional shape of the first rear closed-section structure portion 61 when cut in a plane orthogonal to the extension direction of the first rear closed-section structure portion 61 is annular. That is, the sectional shape of the first rear closed-section structure portion 61 is a closed-section shape. Although not shown in the drawings, the second rear closed-section structure portion 62 is a hollow portion extending linearly along a direction inclined with respect to the left-right direction. That is, the sectional shape of the second rear closed-section structure portion 62 when cut in a plane orthogonal to the extension direction of the second rear closed-section structure portion 62 is annular.

As described above, the front closed-section structure portion 55, the first intermediate closed-section structure portion 57, the second intermediate closed-section structure portion 58, the first rear closed-section structure portion 61, and the second rear closed-section structure portion 62 have a closed-section structure. Therefore, the mechanical strength is higher than the mechanical strength of the outer peripheral side flat plate portion 46, the first inner peripheral side flat plate portion 49, and the second inner peripheral side flat plate portion 53. Further, the internal spaces of the front closed-section structure portion 55, the first intermediate closed-section structure portion 57, the second intermediate closed-section structure portion 58, the first rear closed-section structure portion 61, and the second rear closed-section structure portion 62 communicate with each other.

As shown in FIG. 1, the right and left ends of the front end of the shear panel 40 are fixed to the lower surface of the support portion 24 of the right and left side rails 22. The right and left ends of the front end of the shear panel 40 are fixed to the lower surface of the support portion 24 by using, for example, bolts that penetrate the right and left ends and the lower surface (lower panel 17) of the support portion 24 in the vertical direction, and a weld nut that is fixed to the upper surface of the lower panel 17 and to which the bolt is screwed. The support portions 24 of the right and left side rails 22, the right and left brackets 25, and the front closed-section structure portion 55 are positioned on a straight line extending in the left-right direction as viewed in plan. Further, the right and left ends of the vicinity of the rear end of the shear panel 40 are fixed to the lower surface of the connected portion 23 of the right and left side rails 22. That is, a portion located on the right side of the intersection of the second intermediate closed-section structure portion 58 and the first rear closed-section structure portion 61 is fixed to the right-side connected portion 23. Further, a portion located on the left side of the intersection of the first intermediate closed-section structure portion 57 and the second rear closed-section structure portion 62 is fixed to the left-side connected portion 23. A portion located on the right side of the right intersection portion of the shear panel 40 is fixed to the lower surface of the connected portion 23 by using, for example, a bolt that penetrates the portion and the lower surface (lower panel 17) of the connected portion 23 in the vertical direction, and a weld nut that is fixed to the upper surface of the lower panel 17 and to which the bolt is screwed. Similarly, a portion located on the left side of the intersection portion on the left side of the shear panel 40 is fixed to the lower surface of the connected portion 23 by using, for example, a bolt that penetrates the portion and the lower surface (lower panel 17) of the connected portion 23 in the vertical direction, and a weld nut that is fixed to the upper surface of the lower panel 17 and to which the bolt is screwed. As shown in FIG. 1, the bent portions 22A of the right and left side rails 22 are located forward of the front edge portion of the shear panel 40. The second intermediate closed-section structure portion 58 and the first rear closed-section structure portion 61 may be fixed to the rear end of the right side rail 22 via the connection pin 29. Further, the second intermediate closed-section structure portion 58 and the vicinity of the intersection portion on the left side of the first rear closed-section structure portion 61 may be fixed to the rear end of the left side rail 22 via the connection pin 29.

### Action and Effect

Next, the operation and effects of the embodiment will be described.

Here, it is assumed that a frontal collision of the vehicle 10 occurs. In this case, the backward movement force of the suspension member 15 caused by the frontal collision is transmitted to the battery 70 via the right and left connection brackets 27 and the rear end 43 of the shear panel 40, and the large and heavy battery 70 receives the movement force. As a result, the side rails 22 and the shear panel 40 receive a forward reaction force from the battery 70. Further, the shear panel 40 has a front closed-section structure portion 55 extending along a straight line connecting the right and left brackets 25, and the portions of the shear panel 40 that are located next to the front closed-section structure portion 55 in the left-right direction as viewed in plan are fixed to the support portions 24 of the side rails 22. Furthermore, two portions of the shear panel, namely right and left portions of the shear panel 40, are fixed to the connected portions 23 of the right and left side rails 22. Further, since the rear portion of the first intermediate closed-section structure portion 57 of the shear panel 40, the rear portion of the second intermediate closed-section structure portion 58, the first rear closed-section structure portion 61, and the second rear closed-section structure portion 62 form an annular structure, the mechanical strength of the rear portion of the shear panel 40 is high. Therefore, the mechanical strength of the portion located rearward of the support portion 24 and the support portion 24 of the right and left side rails 22 is higher than the mechanical strength of the portion located forward of the support portion 24 of the side rails 22. Further, the right and left side rails 22 are provided with bent portions 22A. Therefore, when the side rails 22 receive a forward reaction force from the battery 70, the bent portions 22A of the right and left side rails 22 are intentionally deformed (bent). That is, when the frontal collision of the vehicle 10 occurs, the impact load can be absorbed by the side rails 22 by deforming the bent portion 22A while reducing the deformation amounts of the rear portions of the right and left side rails 22.

Next, it is assumed that the steering wheel of the vehicle 10 is rotated by the occupant. In this case, a force in the vehicle width direction is transmitted from the second arm 31 to the support portion 24 from the right and left brackets 25. However, the front closed-section structure portion 55 of the shear panel 40 extends along a straight line connecting the right and left brackets 25 as viewed in plan. In addition, the mechanical strength of the front closed-section structure portion 55 is higher than the mechanical strength of the outer peripheral side flat plate portion 46, the first inner peripheral side flat plate portion 49, and the second inner peripheral side flat plate portion 53. Furthermore, the mechanical strength of the support portion 24, which is a portion where the bracket 25 of the side rail 22 is fixed, tends to be higher than other portions of the side rail 22. Therefore, a part of the force in the vehicle width direction transmitted from the bracket 25 to the side rail 22 (the support portion 24) is easily received by the front closed-section structure portion 55 connected to the support portion 24. Furthermore, the mechanical strength of the connected portion 23 of the side rail 22 fixed to the front side member 14 is likely to be higher than other portions of the side rail 22. Therefore, another part of the force in the vehicle width direction transmitted from the bracket 25 to the side rail 22 (the support portion 24) is likely to be received by the second intermediate closed-section structure portion 58 connected to the connected portion 23. Further, the force transmitted to the support portions 24 of the right and left side rails 22 is transmitted from the shear panel 40 and the right and left connection brackets 27 to the battery 70, and is received by the battery 70. This configuration allows to improve the rigidity of the support portions 24 of the side rails 22, namely the portions that receive the force transmitted from the lower arms 30 to the suspension member 15 (side rails 22) when the steering wheel is steered.

Although the vehicle lower part structure according to the embodiment has been described above, the present disclosure can be appropriately modified in design without departing from the gist thereof.

For example, the rear ends of the right and left side rails 22 may be directly fixed to the front portion of the battery 70 without using the connection bracket 27.

The rear ends of the right and left side rails 22 may be connected to the front portion of the battery 70 directly or through the connection bracket 27, while the rear end 43 of the shear panel 40 may not be connected to the battery 70.

The rear ends of the right and left side rails 22 may be directly or indirectly connected to right and left rockers (not shown) which are body frame members.

The shear panel 40 may have a solid structure instead of a hollow structure.

What is claimed is:

1. A vehicle lower part structure, comprising:
a suspension member installed in a vehicle and including a cross member, a pair of right and left side rails, and arm support portions, the side rails being connected to the cross member and extending in a vehicle front-rear direction, rear ends of the side rails being connected to a battery, and each of the arm support portions being provided on an intermediate portion in a front-rear direction of a corresponding one of the side rails and supporting a corresponding one of lower arms that support front wheels whose steering angle changes when a steering wheel is steered; and
a shear panel located between rear portions of the side rails as viewed in plan and including a front closed-section structure portion, the front closed-section structure portion extending along a straight line connecting the right and left arm support portions as viewed in plan, and connected to the side rails.

2. The vehicle lower part structure according to claim 1, wherein:
each of the side rails includes a connected portion connected to a corresponding one of front side members and located rearward of a corresponding one of the arm support portions; and
the shear panel includes
a first intermediate closed-section structure portion connecting a right end of the front closed-section structure portion and the connected portion of the left side rail as viewed in plan and connected to the connected portion of the left side rail, and
a second intermediate closed-section structure portion connecting a left end of the front closed-section structure portion and the connected portion of the right side rail as viewed in plan and connected to the connected portion of the right side rail.

3. The vehicle lower part structure according to claim 2, further comprising:
a first rear closed-section structure portion extending from a right end of the second intermediate closed-section structure portion obliquely rearward to left as viewed in plan; and
a second rear closed-section structure portion extending from a left end of the first intermediate closed-section structure portion obliquely rearward to right as viewed in plan, a rear end of the second rear closed-section structure portion being connected to a rear end of the first rear closed-section structure portion and the battery.

4. The vehicle lower part structure according to claim 1, wherein each of the side rails includes a bent portion located forward of the front closed-section structure portion.
